(19) United States
(12) Patent Application Publication
(10) Pub. No.: US 2019/0355388 A1
(43) Pub. Date: Nov. 21, 2019

(54) OPTICAL DISC

(71) Applicant: Panasonic Intellectual Property Management Co., Ltd., Osaka (JP)

(72) Inventors: YOSHIHIRO KAWASAKI, Okayama (JP); HIROKI KOBAYASHI, Okayama (JP); YU TOKORO, Aichi (JP)

(21) Appl. No.: 16/526,299

(22) Filed: Jul. 30, 2019

Related U.S. Application Data
(63) Continuation of application No. PCT/JP2017/041968, filed on Nov. 22, 2017.

(30) Foreign Application Priority Data
Feb. 13, 2017 (JP) 2017-024068

(51) Int. Cl. G11B 7/24035; G11B 7/007

(52) U.S. Cl. CPC G11B 7/24035; G11B 7/007

(57) ABSTRACT

An optical disc is formed by bonding a first information recording medium to a second information recording medium. The first information recording medium includes a first substrate having opposed first and second surfaces, at least one dielectric film, at least one recording film, and a cover layer. The second information recording medium includes a second substrate having opposed third and fourth surfaces, at least one dielectric film, at least one recording film, and a cover layer. The second surface of the first substrate is bonded to the fourth surface of the second substrate. At least one of the second surface or the fourth surface includes a depression and a projection. The depression is formed in a thickness direction of the optical disc. The projection is provided inside the depression at a predetermined distance or longer from an outer circumferential edge of the depression in a radial direction of the optical disc.

### TECHNICAL FIELD

The present disclosure relates to an optical disc that enables information to be recorded on or read from its both surfaces.

### BACKGROUND ART

Some known optical discs that are designed to store large amounts of information enable information to be recorded on or read from both surfaces. PTL 1 discloses one method of manufacturing double-sided optical discs in which two surfaces of an optical disc are manufactured independently and then bonded to each other.

PTL 1 suggests a possible problem associated with the bonding process. More specifically, some projections such as burrs may be formed on the bonded surfaces to cause a distance between both the surfaces to fall outside an intended range or to permit entry of air into an interface between the bonded surfaces. PTL 1, however, teaches that this problem can be prevented by forming depressions in the bonded surfaces in a thickness direction of the optical disc and setting heights of the burrs to be smaller than a step height of the depressions.

### CITATION LIST

### Patent Literature

PTL 1: Unexamined Japanese Patent Publication No. 2001-047471

### SUMMARY

The inventors of the present application have found another possible problem, other than the problem suggested by PTL 1, associated with, for example, a process of manufacturing an optical disc that enables information to be recorded on or read from its both surfaces.

More specifically, an optical disc has two surfaces: an A-side information recording medium and a B-side information recording medium. When the A-side and B-side information recording media are manufactured, one or more dielectric films and recording films are formed on each substrate in the A-side and B-side information recording media. Then, a cover layer used as a protective film is laminated over the dielectric and recording films of each recording medium. To form this cover layer, a transparent protective film resin used as a material of the cover layer is dropped onto a central area of a disc that is rotating. After having landed on the disc, the resin material spreads to an outer circumferential edge of the recording medium while becoming thinner, due to centrifugal force. Eventually, the resin material reaches a back surface of the recording medium through the outer circumferential edge of the disc.

When the resin material reaches the rear surface of the recording medium, the resin stays and is cured on the back surface. This resin may perform the interference when A-side and B-side information recording media are bonded to each other. This might cause a problem, for example, that a distance between both the surfaces of the manufactured optical disc is not uniform or that air enters into the interface between the bonded surfaces. Such problems are prone to lower quality of the optical disc.

An object of the present disclosure is to provide an optical disc that overcomes the above problem.

A first aspect of the present application relates to an optical disc that enables information to be recorded on and read from its both surfaces. This optical disc is formed by bonding a first information recording medium to a second information recording medium. The first information recording medium includes: a first substrate having opposed first and second surfaces; at least one dielectric film; at least one recording film; and a cover layer. The at least one dielectric film and the at least one recording film are formed on the first surface of the first substrate. The cover layer protects the at least one dielectric film and the at least one recording film. The second information recording medium includes: a second substrate having opposed third and fourth surfaces; at least one dielectric film; at least one recording film; and a cover layer. The at least one dielectric film and the at least one recording film are formed on the third surface of the second substrate. The second surface of the first substrate is bonded to the fourth surface of the second substrate. In the optical disc, at least one of the second surface of the first substrate of the first information recording medium or the fourth surface of the second substrate of the second information recording medium includes a depression and a projection. The depression is formed in a thickness direction of the optical disc; the projection is provided inside the depression at a predetermined distance or longer from an outer circumferential edge of the depression in a radial direction of the optical disc.

An optical disc of the present disclosure which enables information to be recorded on or read from its both surfaces suppresses lowering of the quality.

### BRIEF DESCRIPTION OF DRAWINGS

FIG. 1 is a cross-sectional view of an optical disc to be described in an exemplary embodiment.

FIG. 2 illustrates a case where projections are disposed near outer circumferential edges of substrates.

FIG. 3 illustrates a case where the projections are disposed at a predetermined distance from the outer circumferential edges of the substrates.

FIG. 4 illustrates a case where the projections in only one of the information recording media are disposed at a predetermined distance from an edge of its outer shape.

FIG. 5 illustrates a configuration in which the projections are disposed on inner circumferential sides of the substrate depressions.

FIG. 6 illustrates locations of projections in the optical disc as seen from the top.

### DESCRIPTION OF EMBODIMENT

An exemplary embodiment will be described in detail below, as appropriate, with reference to the accompanying drawings. Excessively detailed descriptions will sometimes be omitted. For example, a detailed description of a well-known matter and a duplicated description of substantially the same configuration will be omitted in some cases. A reason for this is to avoid unnecessary redundancy of the following description and to facilitate understanding of those skilled in the art.

The inventors (and others) provide the accompanying drawings and the following description to help those skilled in the art sufficiently understand the present disclosure, and thus do not intend to limit the subject matters described in the claims.

### First Eemplary Embodiment

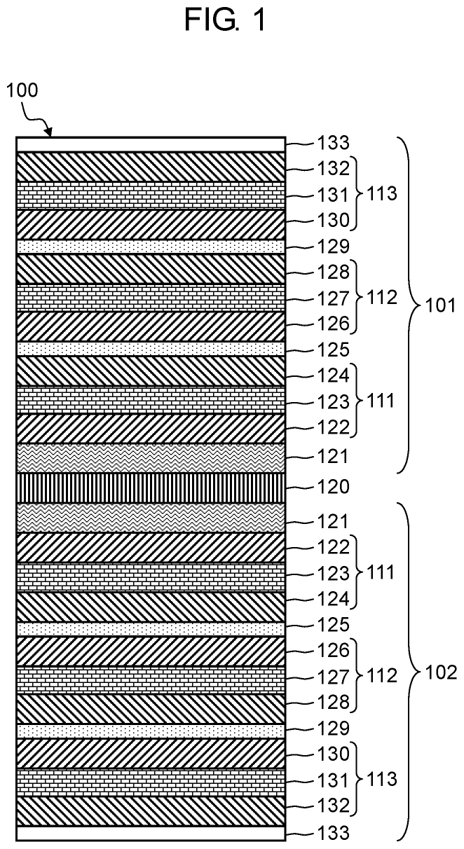

FIG. 1 is a cross-sectional view of an optical disc that will be described in this exemplary embodiment. Optical disc 100 in this exemplary embodiment is a double-sided multilayer optical disc in which three (total six) information layers on or from which information is to be recorded and reproduced are provided on one side of each substrate 121. By irradiating optical disc 100 with laser light from a side of cover layer 133, information can be recorded on and reproduced from the individual information layers.

Optical disc 100 is an information recording medium that includes A-side information recording medium 101, abbreviated as an A side, and B-side information recording medium 102, abbreviated as a B side. A-side information recording medium 101 and B-side information recording medium 102, which are bonded to one another, each enables information to be recorded on or read from its both surfaces. Back surfaces (surfaces opposite to surfaces on which the information layers are formed) of substrates 121 in A-side information recording medium 101 and B-side information recording medium 102 are bonded to each other with bonding layer 120 in-between. Each of A-side information recording medium 101 and B-side information recording medium 102 includes L0 layer 111, L1 layer 112, and L2 layer 113, which are laminated in this order on corresponding substrate 121 with intermediate separation layers 125 and 129, for example, in-between. Furthermore, each of

A-side information recording medium 101 and B-side information recording medium 102 further includes cover layer 133 provided in contact with corresponding L2 layer 113. Each of L1 layer 112 and L2 layer 113 is a transmissive information layer.

For the sake of convenience, if guide grooves are formed in respective substrates 121 of optical disc 100, one of the surfaces which is closer to laser light is referred as a “groove”, whereas the other surface which is farther from the laser light is referred as a “land” herein. A pit can be formed in (land-groove recording can be performed on) each recording film at a location related to both the groove and the land by increasing recording density (namely, shortening a mark length). Also, a guide groove may be formed in each of intermediate separation layers 125 and intermediate separation layers 129. In fact, the guide groove is preferably formed in each of intermediate separation layer 125 and intermediate separation layer 129, especially when the land-groove recording is performed on both L1 layer 112 and L2 layer 113.

Hereinafter, a description will be given of substrates 121, intermediate separation layers 125 and 129, cover layers 133, and bonding layer 120.

A material of substrates 121 may be resin such as polycarbonate, amorphous polyolefin, and polymethyl methacrylate (PMMA) resins, or glass, for example. An uneven guide groove may be formed, as appropriate, on one of both surfaces of each substrate 121 which is closer to corresponding recording film 123 in order to help guidance of the laser light. Substrates 121 are preferably transparent; however, substrates 121 do not necessarily have to be transparent and alternatively may be translucent. Each substrate 121 has a disc shape that has a thickness of about 0.5 mm and a diameter of about 120 mm, for example.

An uneven guide groove may be formed, as appropriate, on one of both surfaces of substrate 121 which is closer to L0 layer 111 in order to help guidance of the laser light. When the guide grooves are formed in respective substrates 121, as described above, one of the grooves (surfaces) which is closer to the laser light is referred as a “groove” and the other of the grooves (surfaces) which is farther from the laser light is referred as a “land”. For example, a depth of each groove (a step height between the groove surface and the land surface) may be set in a range from 10 nm to 50 nm inclusive. If a land and groove recording technique is employed and performed at high recording density, the groove depth may be set to be deep enough to reduce a crosstalk effect. However, it should be noted that a deeper depth tends to cause lower reflectivity. The groove depth is preferably set in a range from 15 nm to 25 nm inclusive so as to be able to reduce crosstalk and maintain the reflectivity.

Intermediate separation layers 125 and 129 are made of resin, such as photo-curable resin (especially, ultraviolet curable resin) or slowly thermosetting resin. As an example, each of intermediate separation layers 125 and 129 is made of acrylic resin. Each of intermediate separation layers 125 and 129 may exhibit low light absorption for laser light having a wavelength λ, which is used for recording and reproducing. In which case, the laser light can efficiently reach L0 layer 111 and L1 layer 112. Intermediate separation layers 125 and 129 are provided to differently set focal locations on L0 layer 111, L1 layer 112, and L2 layer 113. Thus, a thickness of intermediate separation layers 125 and 129 may be set to be equal to or more than a depth of focus ΔZ, which can be determined by a numerical aperture (NA) of an objective lens and the wavelength λ of the laser light, for example. If a reference of light intensity at a focal point is expected to be 80% of a case of an aplanatic system, ΔZ can be regarded as an approximate value: λ/{2(NA)²}. Alternatively, thicknesses of each intermediate separation layer 125 and each intermediate separation layer 129 may be set to different values, so that it is possible to prevent an effect of a focal point on the back surfaces of L1 layers 112.

Uneven guide grooves may be formed on surfaces of intermediate separation layers 125 and 129 on which the laser light is to be incident. A step height of the guide groove provided in each of intermediate separation layers 125 and 129 and a distance between the groove and the land conforms to the description of the guide grooves provided in substrates 121. In this exemplary embodiment, a depth of the grooves (a step height between the groove surfaces and land surfaces) is set to 30 nm, and a distance between the grooves and lands may be about 0.225 μm. However, these dimensions may be set to any other values.

Cover layers 133 may be made of resin, such as photo-curable resin (especially, ultraviolet curable resin) or slowly thermosetting resin. Each cover layer 133 may exhibit low light absorption for the laser light used. Alternatively, cover layers 133 may be made of resin such as polycarbonate, amorphous polyolefin, and PMMA resins, or glass. A thickness of cover layers 133 may be set in a range from about 40 μm to 80 μm, more specifically from about 50 μm to 65 μm, for example, in which case it is possible to achieve appropriate recording and reproducing at NA of 0.85.

Bonding layer 120, which is provided between the bonded surfaces of A-side information recording medium 101 and B-side information recording medium 102, may be made of resin, such as photo-curable resin (especially, ultraviolet curable resin) or slowly thermosetting resin. Bonding layer 120 may exhibit any level of transparence. More specifically, bonding layer 120 may be either transparent or translucent. In addition, bonding layer 120 may be provided with a film that blocks the laser light. A thickness of bonding layer 120 may be set in a range from about 5 μm to 80 μm, more specifically from about 20 μm to 50 μm.

Next, a description will be given of a configuration of L0 layers 111. Each L0 layer 111 is formed by laminating at least first dielectric film 122, recording film 123, and second dielectric film 124, in this order, on the surface of corresponding substrate 121.

First dielectric film 122 has functions of: controlling signal amplitude by adjusting an optical phase difference; and controlling the signal amplitude by adjusting bulging of record marks. In addition, first dielectric film 122 has functions of: suppressing moisture from entering into recording film 123; and suppressing oxygen from escaping from recording film 123 to the outside.

If optical disc 100 is of a recordable type, for example, optical disc 100 forms bulging parts in recording film 123 as record marks by irradiating recording film 123 with the laser light. Forming such bulging parts can be an irreversible change.

Similar to first dielectric film 122, second dielectric film 124 has functions of: controlling signal amplitude by adjusting an optical phase difference; and controlling the signal amplitude by adjusting bulging of record pits. In addition, each second dielectric film 124 has functions of: suppressing moisture from entering from intermediate separation layer 125 into the recording film 123; and suppressing oxygen from escaping from recording film 123 to the outside. Also, second dielectric film 124 has functions of: suppressing organic matter from entering from intermediate separation layer 125 into recording film 123; and reliably increasing adhesion between L0 layer 111 and intermediate separation layer 125.

Next, a description will be given of a configuration of L1 layers 112. Each L1 layer 112 is formed by laminating at least first dielectric film 126, recording film 127, and second dielectric film 128, in this order, on the surface of corresponding intermediate separation layer 125.

Functions of first dielectric film 126 are the same as the above functions of first dielectric film 122 in L0 layer 111. In addition, first dielectric film 126 also has functions of: suppressing organic matter from entering from intermediate separation layer 125 into recording film 127; and reliably increasing adhesion between L1 layer 112 and intermediate separation layer 125.

Functions of recording film 127 are the same as the above functions of recording film 123 in L0 layer 111.

Functions of second dielectric film 128 are the same as the above functions of second dielectric film 124 in L0 layer 111.

Next, a description will be given of a configuration of L2 layers 113. Each L2 layer 113 is formed by laminating at least first dielectric film 130, recording film 131, and second dielectric film 132, in this order, on the surface of corresponding intermediate separation layer 129.

The configuration of L2 layer 113 is basically the same as the configuration of L1 layer 112.

Functions of first dielectric film 130 are the same as the functions of first dielectric film 126 in L1 layer 112. Therefore, first dielectric film 130 has the same functions as the functions of first dielectric film 122 in L0 layer 111.

Functions of recording film 131 are the same as the functions of recording film 127 in L1 layer 112 and therefore the same as the functions of recording film 123 in L0 layer 111.

Second dielectric film 132 has the same functions as the functions of second dielectric film 128 in L1 layer 112, and therefore has the same functions as the functions of second dielectric film 124 in L0 layer 111.

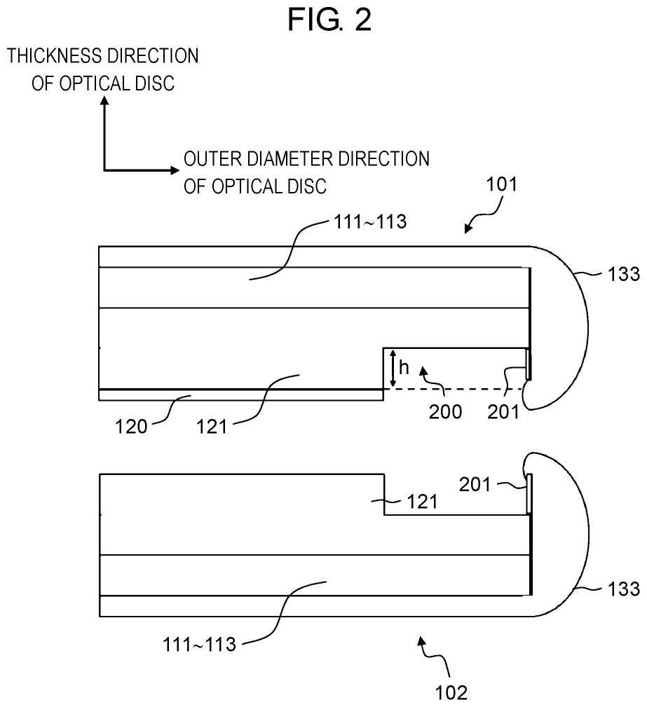

FIG. 2 illustrates a case where projections are disposed near the outer circumferential edges of the substrates. FIG. 2 illustrates, in an enlarged manner, the bonded surfaces of A-side information recording medium 101 and B-side information recording medium 102 described in FIG. 1 and their surrounding area. For the purpose of simplifying the following explanation, L0 layer 111 to L2 layer 113 (first dielectric film 122 to second dielectric film 132) in each of A-side information recording medium 101 and B-side information recording medium 102 in FIG. 2 are not described.

As disclosed in PTL 1, of each substrate 121, a portion near its outer circumferential edge is shorter in length, in a thickness direction of optical disc 100, than a portion on its inner circumferential side. In short, a portion of each substrate 121 near the outer circumferential edge in a radial direction of optical disc 100 corresponds to a depression formed in the thickness direction.

This depression is referred to below as the substrate depression 200, and the description will be continued.

Each substrate 121 is obtained by injecting a molten material resin into a mold die, cooling and solidifying the filled resin, and removing the molded product from the mold die. In this case, a projection, for example, referred to as a “burr”, may be created on a portion of each substrate which is related to a separation line, namely, a parting line, of a plurality of die units constituting the molding die.

In PTL 1, a height of this projection is set to be smaller than height h of substrate depression 200. This configuration overcomes a problem that, when A-side information recording medium 101 is bonded to B-side information recording medium 102, the projections of both recording media are brought into contact with and interfere with each other to make a distance between both the recording surfaces non-uniform.

The inventors of the present application, however, have found another possible problem. This problem is that cover layers 133 may also affect the cause of the interference occurring when A-side information recording medium 101 is bonded to B-side information recording medium 102.

Cover layers 133 are laminated on L2 layers 113 of the respective recording media before A-side information recording medium 101 is bonded to B-side information recording medium 102. A material resin of cover layers 133 is dropped onto central areas of A-side information recording medium 101 and B-side information recording medium 102 each having a disc shape while

A-side information recording medium 101 and B-side information recording medium 102 are rotating. When the resin lands on each recording medium, the resin spreads outwardly over the disc, due to centrifugal force generated by the rotation. This process is referred to as the spin coat process, for example.

After the resin has spread widely over a recording medium having a disc shape while becoming thinner due to the centrifugal force, the resin reaches the back surface of the recording medium through the side surface at the edge. If projection 201 is disposed inside substrate depression 200 near the outer circumferential edge, the material resin of cover layer 133 stays over projection 201. Then, the material resin that has stayed over projection 201 may be cured with its height being greater than height h of substrate depression 200. In this case, cover layers 133 staying over projections 201 might interfere with each other when A-side information recording medium 101 is bonded to B-side information recording medium 102. The present applicant has focused attention on this problem.

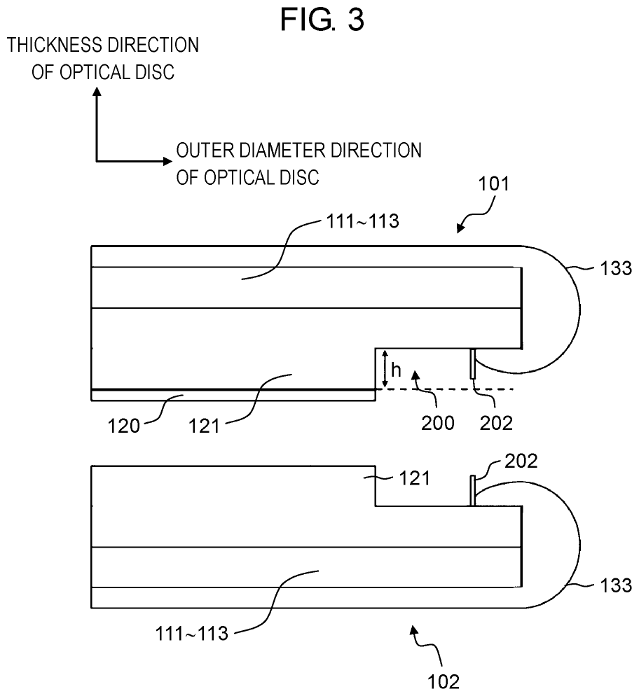

To overcome the above problem, the inventors of the present application have proposed a configuration as illustrated in FIG. 3. FIG. 3 illustrates a case where the projections are disposed at a predetermined distance from the outer circumferential edges of the respective substrates. By disposing projections 202 at the predetermined distance from the outer circumferential edges of respective substrate depressions 200, it is possible to reduce a risk as illustrated in FIG. 2, namely, a risk that the material resin of cover layer 133 may spread to the side surfaces of A-side information recording medium 101 and B-side information recording medium 102 and then cover projections 201 in the thickness direction of optical disc 100. When projections 202 are disposed at the predetermined distance from the outer circumferential edges of respective substrate depressions 200, the material resin of cover layer 133 can further spread by a distance from the outer circumferential edges of optical disc 100 to projections 202. In this way, it is possible to suppress the material resin of cover layer 133 from staying in the thickness direction of optical disc 100.

The inventors of the present application have repeatedly made several attempts and found the following combination as a preferred condition. More specifically, the distance between substrate depressions 200 and the outer circumferential edges of A-side information recording medium 101 and B-side information recording medium 102 is set in a range from about 0.1 mm to 1.0 mm. In addition, the distance between projections 202 and the edge of its outer shape is set in a range from 0.02 mm to 0.08 mm. It is more preferable that each projection 202 be provided at a distance of approximately 0.05 mm.

It is possible to control locations of projections 202 on substrates 121, for example, by changing a location at which a parting line is to be formed in the mold die for use in manufacturing substrates 121. A shape of each projection 202 may be a substantially rectangular parallelepiped shape; however, each projection 202 may have any other shape in the present application. As an alternative example, each projection 202 may have a conical shape or may be curved toward the inner or outer circumferential side.

Substrate depressions 200 are provided, in the thickness direction of optical disc 100, at the outer circumferential edges of substrates 121 in A-side information recording medium 101 and B-side information recording medium 102. Projections 202 are provided inside substrate depressions 200 at the predetermined distance from the outer circumferential edges. Each of information layers in A-side information recording medium 101 and B-side information recording medium 102 includes at least one dielectric film, at least one recording film, and some other films on the surface opposite to the surface of substrate 121 on which substrate depression 200 is provided. Cover layers 133 are laminated over layers each of which includes these dielectric and recording films. When the material resin of cover layer 133 is laminated over each information layer, part of the material resin spreads to the outer circumferential edge of optical disc 100 (A-side information recording medium 101, B-side information recording medium 102) and then reaches the bonded surface of substrate 121. Each projection 202 is disposed so as to escape from a location at which this material resin will spread and stay, for example. Optical disc 100 is formed by bonding substrate 121 of A-side information recording medium 101 to substrate 121 of B-side information recording medium 102.

As described above, the material resin of the cover layers, which are used to protect recording layers of A-side information recording medium 101 and B-side information recording medium 102, may spread to the side surface of optical disc 100 and then may reach substrates 121. Even in which case, the material resin is allowed to spread by a predetermined distance ranging from the outer circumferential edges to projections 202. This can suppress the material resin from staying in the thickness direction of optical disc 100. Since each cover layer is formed with the spin coat process as already described, the material resin of the cover layers is likely to stay at or around the edge of the outer shape of optical disc 100. Thus, by disposing projections 202 at the predetermined distance from the outer circumferential edges of optical disc 100, the resin can be suppressed from staying over projections 202. In this way, it is possible to reduce the risk of the material resin of cover layers interfering with each other when A-side information recording medium 101 is bonded to B-side information recording medium 102.

Both of substrate depressions 200 may be positioned opposite to each other after A-side information recording medium 101 has been bonded to B-side information recording medium 102. Further, projections 202 formed in the above manner may be positioned substantially opposite to each other after

A-side information recording medium 101 has been bonded to B-side information recording medium 102.

### Modification of this Exemplary Embodiment

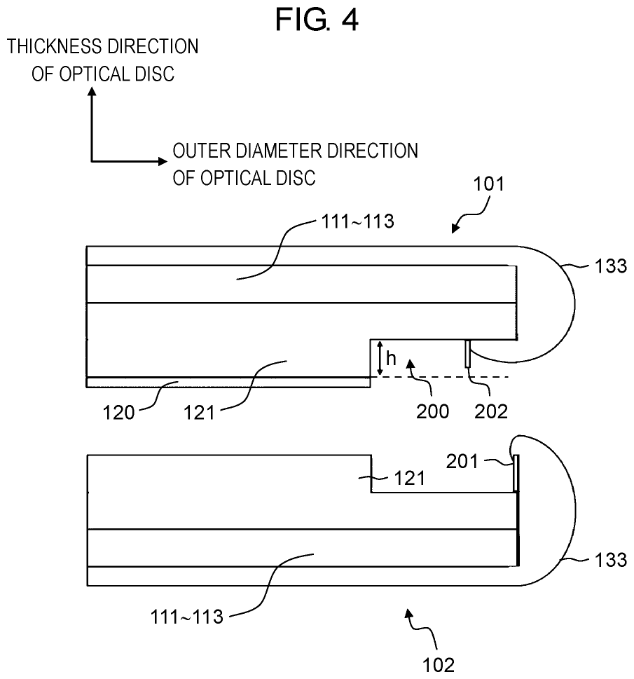

In the example described above, substrate depressions 200 are provided on surfaces of A-side information recording medium and B-side information recording medium 102. Further, projections 202 are provided at the predetermined distance from the respective outer circumferential edges. FIG. 4 illustrates a case where only one of the projections in the respective information recording media is disposed at a predetermined distance from the edge of its outer shape. Only one of projections 202 in the respective information recording media may be disposed at the predetermined distance from the outer circumferential edge. In this case, even if the material resin of cover layer 133 is present over projection 201 in the other recording medium, this material resin stays inside a space defined by substrate depression 200 in one recording medium. Thus, this configuration can avoid the interference when A-side information recording medium 101 is bonded to B-side information recording medium 102.

For the foregoing reason, at least one of substrates 121 in A-side information recording medium 101 and B-side information recording medium 102 may conform to the above configuration.

In short, projections provided in substrates 121 in A-side information recording medium 101 and B-side information recording medium 102 do not necessarily have to be positioned substantially opposite to each other. By forming both the projections at different locations in the radial direction, the above configuration can be achieved.

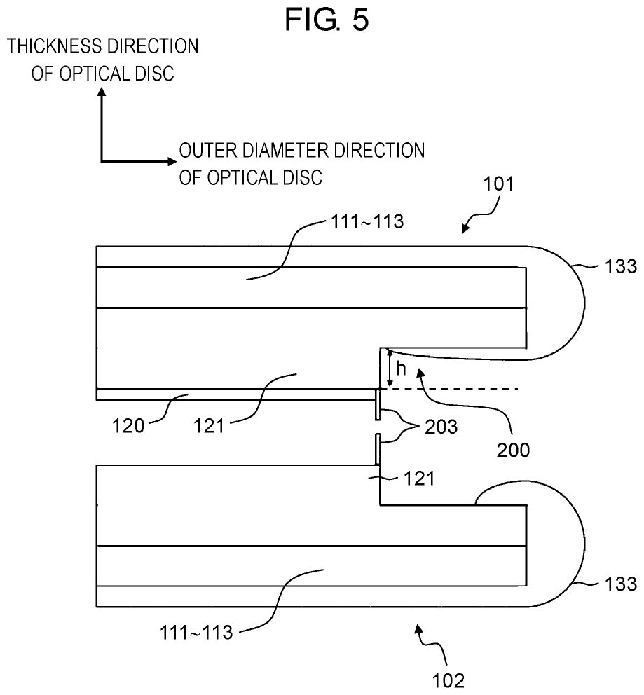

FIG. 5 illustrates a configuration in which the projections are disposed on inner circumferential sides of the substrate depressions. As illustrated in FIG. 5, if projections 203 are provided at innermost circumferential edges in contact with substrate depressions 200, projections 203 may perform the interference when A-side information recording medium 101 is bonded to B-side information recording medium 102. For this reason, it is believed that the projections need to be positioned inside substrate depressions 200.

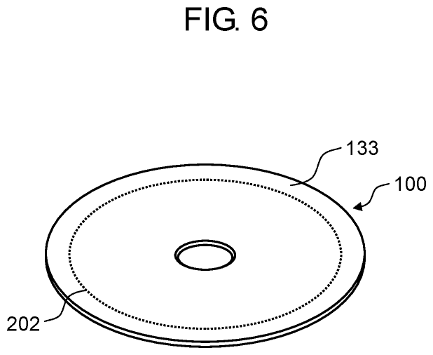

As illustrated in FIG. 6, each projection 202 may be in the form of a complete circle. However, each projection 202 may be in the form of a segment of a circle.

In the example of FIG. 6, each projection 202 forms a single circular shape. However, a plurality of projections 202 may form a single circular shape. This means that a plurality of projections 202 may be present inside each substrate depression 200. In this case, projection 202 positioned on the outermost circular side needs to satisfy the conditions described in this exemplary embodiment.

In the example of this exemplary embodiment, the optical disc employs a recordable type. However, the disclosure in the present application is not limited to this configuration. As an alternative example, a recordable and erasable type of optical disc may be applied to the present application. In short, any type of optical disc that enables information to be optically recorded on or read from its both surfaces may be applicable.

As described above, the exemplary embodiment has been described as an example of the technique in the present disclosure. For that purpose, the accompanying drawings and the detailed description have been provided.

In order to illustrate the above technique, the components described in the accompanying drawings and the detailed description can include not only components necessary to solve the problem but also components unnecessary to solve the problem. For this reason, it should not be immediately recognized that those unnecessary components are necessary just because those unnecessary components are described in the accompanying drawings and the detailed description.

Since the above exemplary embodiment is intended to illustrate the technique in the present disclosure, various modifications, replacements, additions, removals, or the like can be made without departing from the scope of the accompanying claims or the equivalent thereof.

### INDUSTRIAL APPLICABILITY

An optical disc disclosed in the present application is industrially applicable as a recording medium on which information is to be recorded.

### REFERENCE MARKS IN THE DRAWINGS

100: optical disc

101: A-side information recording medium

102: B-side information recording medium

111: L0 layer

112: L1 layer

113: L2 layer

120: bonding layer

121: substrate

122: first dielectric film

123: recording film

124: second dielectric film

125: intermediate separation layer

126: first dielectric film

127: recording film

128: second dielectric film

129: intermediate separation layer

130: first dielectric film

131: recording film

132: second dielectric film

133: cover layer

200: substrate depression

201: projection

202: projection

203: projection

1. An optical disc that enables information to be recorded on and read from both surfaces, the optical disc comprising:
a first information recording medium; and
a second information recording medium bonded to the first information recording medium,
wherein
the first information recording medium includes a first substrate having opposed first and second surfaces, at least one dielectric film, at least one recording film, and a cover layer, the at least one dielectric film and the at least one recording film being formed on the first surface of the first substrate, the cover layer protecting the at least one dielectric film and the at least one recording film,
the second information recording medium includes a second substrate having opposed third and fourth surfaces, at least one dielectric film and at least one recording film, and a cover layer, the at least one dielectric film and the at least one recording film being formed on the third surface of the second substrate, the cover layer protecting the at least one dielectric film and the at least one recording film,
the second surface of the first substrate is bonded to the fourth surface of the second substrate,
at least one of the second surface of the first substrate of the first information recording medium or the fourth surface of the second substrate of the second information recording medium includes:
a depression formed in a thickness direction of the optical disc, and
a projection that is provided inside the depression and that is positioned at a predetermined distance or longer from an outer circumferential edge of the depression in a radial direction of the optical disc.

2. The optical disc according to claim 1, wherein
each of the second surface of the first substrate of the first information recording medium and the fourth surface of the second substrate of the second information recording medium includes the depression, and
the depression of the first information recording medium and the depression of the second information recording medium are positioned substantially opposite to each other in a state where the first information recording medium is bonded to the second information recording medium.

3. The optical disc according to claim 2, wherein
each of the second surface of the first substrate of the first information recording medium and the fourth surface of the second substrate of the second information recording medium includes the projection inside the depression of each of the first information recording medium and the second information recording medium, and
the projection of the first information recording medium and the projection of the second information recording medium are positioned substantially opposite to each other in the state where the first information recording medium is bonded to the second information recording medium.
